(19) United States
(12) Patent Application Publication
(10) Pub. No.: US 2013/0002258 A1
(43) Pub. Date: Jan. 3, 2013

(54) DEVICE FOR DIELECTRIC PERMITTIVITY AND RESISTIVITY HIGH TEMPERATURE MEASUREMENT OF ROCK SAMPLES

(75) Inventors: Patrice Ligneul, Al-Khobar (SA); Fabrice Pairoys, Al-Kholar (SA); Paolo Primiero, Udine (IT); Tianhua Zhang, Al-Khobar (SA); Salah Mohammed Al-Ofi, Al-Khobar (SA)

(73) Assignee: Schlumberger Technology Corporation, Cambridge, MA (US)

(21) Appl. No.: 13/173,753

(22) Filed: Jun. 30, 2011

(51) Int. Cl. G01V 3/00

(52) U.S. Cl. 324/376

(57) ABSTRACT

Systems and methods are described for determining dielectric permittivity for core plugs extracted from the field or cores re-saturated with various fluids. The relative dielectric constant of reservoir core plugs is measured in controlled condition of temperature, pressure and fluid saturation within a confined cell. Four-points resistivity measurements of the rock sample in the confined cell is also provided under the controlled temperature, pressure and fluid saturation conditions.

### FIELD

This patent specification generally relates to measurement of properties of subterranean rock samples. More particularly, this patent specification relates to devices and methods for temperature controlled electrical measurements on such rock samples.

### BACKGROUND

Among the reservoir characterization technologies devoted to oilfields, complex permittivity measurements can provide information on the water saturation and the cementation factor of the rock formation in the vicinity of the borehole. Complex permittivity can be obtained with tools such as the “Electromagnetic propagation tool” (operating at one frequency close to 1.1 GHz) or more recently introduced, the “Array Dielectric tool” working at various frequencies in the range of 24 MHz to 1 GHz.

The measurement can be complemented by measurements on cores extracted from the formation in laboratories and especially for cores in “native conditions” i.e. saturated with the fluids in place at the moment of their extraction. For instance the oil still in place should be considered “live oil” which means that dissolved gases are still in the fluid and it would be useful to make measurements in High-Pressure High-Temperature (HPHT) conditions to respect the nature and the state of the fluids. In general, the pressure should be high enough to ensure that water does not vaporize, that asphaltenes do not precipitate, and that gas does not diffuse out of the core for the given temperature of the test (which can be 175 C to 200 C, or even higher for certain applications such as deep gas reservoirs).

There are three main features in a rock system important for understanding the broadband dielectric response: the rock solid polarization, fluid polarization, and rock-fluids interaction in the polarization process. In addition, in certain circumstances the fluid-fluid interfacial polarization can provide further information.

Schlumberger's Dielectric Scanner tool measures the characteristics of propagation of travelling electromagnetic waves between emitting and receiving antennae. The dielectric permittivity and the conductivity of the geological formation at various frequencies are deduced from these data by inversion methods. From these physical parameters, reservoir properties such as cementation factor and water saturation can be estimated by way of dielectric “mixing” laws (reflecting the effect of each component in the wave propagation). As the dielectric permittivity values of the matrix and the fluids are separately entered in the mixing law, they should all be accurately known in order to reliably estimate the reservoir properties. The simplest mixing law useful for the interpretation of the complex permittivity measurements in oil reservoirs is a volumetric distribution of the effect on the complex wave number of the electromagnetic propagating wave; the law is called the CRIM's law (reputed valid at frequencies around and greater that 1 MHz):

\sqrt{∈*}=S_{w}φ\sqrt{∈_{w}*}+(1−S_{w})φ\sqrt{∈ₒᵢ}+(1−φ)\sqrt{∈ᵣₖ}

### Where:

∈*=∈+jσ/ω∈₀ Complex relative permittivity as measured by the tool;
∈ is the real part of the complex permittivity, generally called “dielectric constant” or relative permittivity;
σ is the conductivity (S/m), ω=2πf the angular frequency of the signal;
∈₀ the dielectric permittivity of vacuum;
S_{w} Water saturation of offered volume, (1−S_{w}) is the oil saturation;
φ Rock porosity (% of void volume);
(1−φ) is the rock matrix volume;
∈_{w}* the water complex permittivity depends on temperature and salinity, which can be inferred if the brine is known;
∈ₒᵢ Oil dielectric constant (real, since oil conductivity is generally very low); and
∈ᵣₖ Matrix dielectric constant (real, since rock conductivity is generally very low).

Note that the matrix dielectric constant (the real part of permittivity) can vary over a relatively large range (from 3 to 10 for instance). The water dielectric constant is in the range of 50-100, and salinity can be assessed by various means. The conductivity of the medium is largely dependent on the conductivity of the water.

The measurement of dielectric permittivity on core samples allows continuous spectroscopy recording (in a large range of frequencies). The data can be analyzed to estimate the signature of various components in oil/brine/gas/rock and any additive in the system, the effect of wettability, and the effect of the rock structure.

In SPE Journal, Vol. 4, No. 4, December 1999, by Buu-Long Nguyen, et al. a cell is discussed that uses a flooding system with a measurement cell made of a central electrode and the ground external electrode around the core. However, there is no discussion of making measurements with pressure and/or temperature conditions that approach downhole conditions.

### SUMMARY

According to some embodiments, systems and methods are described for analyzing properties of a core sample of rock from a subterranean rock formation. The systems includes a container to hold the core sample; a temperature control system adapted to maintain the core sample at elevated temperatures; and a plurality of electrodes dimensioned and arranged to contact the core sample so as to make dielectric measurements on the core sample. According to some embodiments, the elevated temperature is at least 100 C-150 C.

According to some embodiments, the container is sealed and adapted to maintain the core sample at an elevated pressure of at least 200 bar. The system may further comprise a fluid delivery system adapted to expose the core sample to one or more fluids that are similar in properties to fluids found in the subterranean rock formation. The fluid delivery system includes two conduits for delivering and collecting the one or more fluids, the two conduits preferably being electrically insulated from the core sample. A number of resistivity electrodes are also included that preferably allow for 4-point resistivity to be measured on the core sample.

### BRIEF DESCRIPTION OF THE FIGURES

The present disclosure is further described in the detailed description which follows, in reference to the noted plurality of drawings by way of non-limiting examples of exemplary embodiments, in which like reference numerals represent similar parts throughout the several views of the drawings, and wherein:

FIG. 1 is a cross section of a device for making high temperature resistivity and dielectric measurements on rock samples under controlled fluid saturation conditions, according to some embodiments;

FIG. 2 is a bottom view of a fluid distribution interface and co-axial dielectric probe, according to some embodiments;

FIG. 3 illustrates numerical modelling results of the magnetic field H iso-amplitude lines inside a core plug feed by a coaxial probe, according to some embodiments;

FIGS. 4A-B are plots illustrating the effect of confinement by a metallic core holder instead of a Teflon core for 3 plugs tested with and without metallic core holder, according to some embodiments; and

FIGS. 5A-B are plots illustrating the effect of confinement by a metallic core holder instead of a Teflon core holder in air, with a low loss dry carbonate sample, according to some embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems, processes, and other elements in the invention may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicate like elements.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

According to some embodiments systems and methods are provided for determining the relative dielectric constant of reservoir core plugs in controlled condition of temperature, pressure and fluid saturation. The techniques described herein can be used for various applications, such as the effect of wettability between the rock matrix and the oil, gas and brine, the effect of various additives, brines, polymers etc.

According to some embodiments, an apparatus is described that combines measurements of complex permittivity and 4 points resistivity measurement of rock samples in a confined cell (referred to herein as a core holder) in high pressure and high temperature conditions with controlled conditions of fluid saturation. Such a device is especially useful in connection with the recent wireline tools such as Schlumberger's Dielectric Scanner tool, and in general whenever there is a need to limit uncertainties and ascertain better knowledge of the oil reservoir in terms of complex permittivity and resistivity saturation. According to some embodiments, the device can be used for high-end calibrations for specific rocks and fluids in the frame of reservoir sampling analysis activities.

One motivation for coupling the classical resistivity measurement (called 4-point resistivity) at low frequencies (less that 1 MHz), and the dielectric response is to better estimate the cementation factor of the Archie's law that links the Water saturation to the porosity and the formation resistivity:

$${S}_{w}^{n} = \frac{1}{{φ}^{m}} \frac{{R}_{w}}{{R}_{t}} .$$

The coefficient m is given in normal resistivity cells by saturating the core plug with water only, φ being known and then S_{w}ⁿ being then equal to 1, Rₜ being the effective measurement, R_{w} is known when salinity and temperature are known or by simple direct measurements:

$$m = \frac{L n ( \frac{{R}_{w}}{{R}_{t}} )}{L n φ} .$$

The complex permittivity measurement at various frequencies provide curves that may be affected by the electric path in the rock sample. The inversion of the dielectric spectroscopy curves allow knowledge of m.

The fact that the brine circulating in the core rock may have a high conductivity suggests that in some cases it may be useful to insulate the brine circuit from the grounding and metallic parts of the core holder.

Another potential outcome from the measurements on cores is regarding the effect of wettability. In Electrical Measurements in the 100 Hz to 10 GHz Frequency Range for Efficient Rock Wettability Determination, Nicola Bona et al. March 2001 SPE Journal, it is shown that wettability can affect the dielectric dispersion curves in the low frequency range. Additionally, for calibration purposes, an air reference can be taken for each measurement for inversion of the reflection (or/and transmission) coefficients of electromagnetic stimulation of the probe/sample interface.

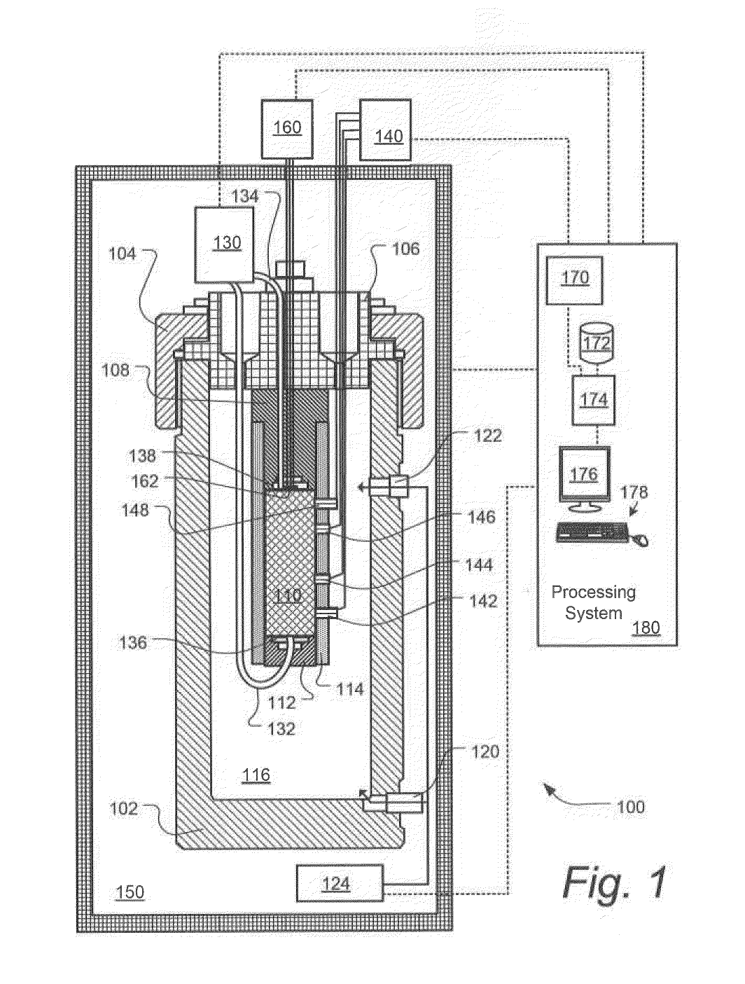

FIG. 1 is a cross section of a device for making high temperature resistivity and dielectric measurements on rock samples under controlled fluid saturation conditions, according to some embodiments. In general, dielectric measurements on core samples extracted from the field depend on fluid saturation, fluid properties (oil, brine, additives, possibly CO2, etc.), rock properties, wettabilities of fluids, temperature and indirectly on pore pressure.

According to some embodiments, the device 100 provides for resistivity measurements of the core sample at lower frequencies (e.g. on the order of 100 kHz) and the complex permittivity measurements of the core sample at higher frequencies (typically from 1 MHz to 3 GHz), all under controlled conditions of fluid saturations that can be adjusted. According to some embodiments, the device 100 provides laboratory support for tools such as an array dielectric scanner tool, by providing measurements at reservoir conditions.

The device 100 provides for measurement of complex dielectric permittivity at high temperature and high pressure on a core sample 110 having small dimensions (e.g. cylindrical plugs of about 1.5″ diameters-1.5″ height). The device 100 allows for extrapolating data at reservoir conditions, and in controlled saturation environment of various fluids, with measurements of characteristics that combine 4 points resistivity, saturation control by fluid circulation, and dielectric permittivity. According to some embodiments, additional measurements can be performed using the device 100 at the same high pressure and high temperature conditions. For example, ultrasonic measurements can be carried out using the second face of the plug 110 in the case of reflection measurements.

According to some embodiments, the desired temperature is defined by the downhole conditions to be simulated. According to some embodiments, the device 100 is designed to reach 250° C. The desired pressure rating varies by application. For example in the case of gas saturated plugs it is desirable to maintain the reservoir conditions (which can be, for example 1000-1300 Bar). For non-gas saturated samples the pressure may be limited to 200/300 bars, (3000/4500 psi).

The device 100 can be used to test core plugs in “native state” (in terms of pressure and temperature conditions) as requested for the initial evaluation of the core just extracted from the formation. According to some embodiments the measurements are made in reflection mode. According to other embodiments, the device 100 is equipped with a transmission core holder that can provide for transmission mode measurements.

The core 110 is inserted in a rubber sleeve 114, which is equipped with 4 electrodes 142, 144, 146, and 148 that can be used for resistivity measurement (4R). According to some embodiments, two of the four electrodes 142 and 148 are mounted on the top and bottom faces of the plug 110 instead of on the sides as shown in FIG. 1. The electrodes 142, 144, 146, and 148 are electrically connected to resistivity measurement electronics.

A co-axial dielectric probe 162 is installed so as to electrically contact the central section, the upper face of plug 110. Dielectric probe 162 is electrically connected to dielectric measurement electronics 160 which records dielectric measurement 66, under saturation changes and pore pressure (Flow and pore P) that is controlled by the pore pressure and flooding control system 130. Pore pressure and flooding control system 130 controls the flow and makes pore pressure measurements using a lower fluid conduit 132 that is in fluid communication with the lower face of plug 110 and an upper fluid conduit 134 that is in fluid communication with the upper face of plug 110. According to some embodiments, the fluid conduits 132 and 134 should be electrically insulated from the core plug 110 in such a way that they do not affect resistivity measurements. According to some embodiments, the conduits are either made of a very low conductive material or appropriately coated.

Confinement is achieved due to the pressure around the sleeve 114 and pushing the lower end piece 112 as a piston to compress the upper and lower faces of core 110 against the fluid and electrical contacts on the upper end piece 108 and lower end piece 112.

According to other embodiments, the upper and/or lower end pieces 108 and 112 hold other devices, such as ultrasonic transducers and/or a second dielectric probes for measurements in transmission mode measurements.

The chamber 116, which is defined by lower walls 102, upper lid 106 and sealing ring 104, is filled with a pressure confinement fluid such as hydraulic oil of distilled water and is controlled via injection ports 120 and 122.

The sleeve 114 wraps the core plug 110 and is equipped, as described, with electrodes 142, 144, 146, and 148 for 4 points resistivity measurements. The sleeve 114 presses on the plug 110 to avoid contamination by the fluid used for pressure confinement.

According to some embodiments, the electrodes 142, 144, 146, and 148 can be of two kinds, either on the section faces of the core plug (2 point measurements), two electrodes can be added to the sleeve for a 4 point measurement.

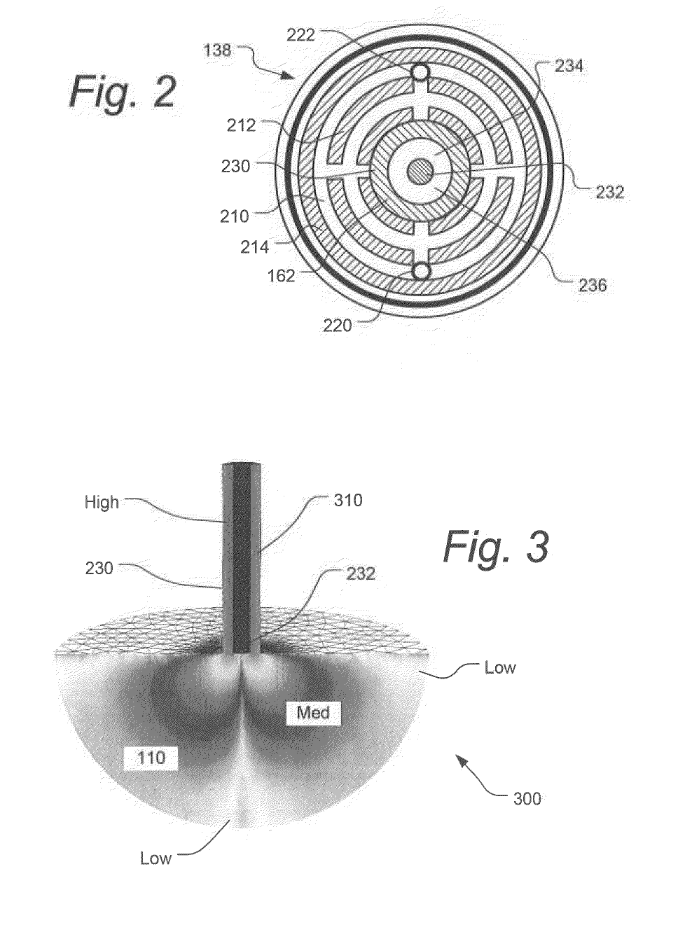

The dielectric probe 162 for measuring permittivity is composed of the extremity of a coaxial probe, is pressed gently in contact with the upper face of rock plug 110. The design of the dielectric probe will be specific to the cell, an example of which is shown in and described more fully with respect to FIG. 2. According to one example, the open end of probe 162 is made of a pressure resistant material (such as sapphire or diamond) because it will be in direct contact with the pressurized inner cell.

For saturation control, the flooding distribution interfaces 136 and 138 are designed for distributing the fluid homogeneously on both side of the core plug. The design of interfaces 136 and 138 should reflect the fact that they are used in combination with electrodes (according to some embodiments) and in the case of upper interface 138, with dielectric probe 162. An example is shown in FIG. 2.

Temperature and pressure sensors, not shown, are located inside the chamber 116 and are used to control confinement, and ports 120 and 122 through the core holder wall 102. The confining pressure is generated by HPHT cylinder pump 124. The pump 124 is thermalized inside the oven 150. The pump 124 has a volume chamber of 100 cc, at the pressure 200 bar to 1300 bars, with a temperature rating of 150° C. to 200° C. The flow rate of pump 124 is adjustable from 0.1 cc/day to 15 cc/day. According to other embodiments, the specification of pump 124 is different, depending upon the expected measurement condition requirements.

According to some embodiments, the pore pressure and flooding control system 130 is based on two cylinders for generating the flow during the measurements while keeping pressure and temperature constant. The pumps of system 130 are of the same characteristics as the confining pressure pump 124, but uniformly changing the fluid inside the chamber with independent control of the upstream and downstream pressure.

According to some embodiments, in order to provide for flooding at both sides of the core sleeve, an adjustment for various plug lengths means that lower conduit 132 has at least one loop for flexibility. The flooding circuit is preferably electrically insulated from the core holder 100 grounding since in the presence of conducting brine leakages of current are expected. All the brine circuit must be closed and insulated. According to some embodiments, a non-conductive non-miscible fluid is used to push the brine from the reservoir up the measurement space.

The oven 150 allows the temperature of the system to be controlled. Inside the oven 150 are gathered the core holder and the valves and plumbing system for the flooding equipment. Connections through the oven wall towards the acquisition devices are in sufficient number. According to some embodiments additional connections through the wall are created for flexibility of other experiments and measurements.

Processing system 180 is used to provide control to pump 124, pore pressure and flooding control system 130, resistivity electronics 140, oven 150 and dielectric measurements electronics 160. Processing system 180 preferably includes one or more central processing units 174, storage system 172, communications and input/output modules 170, a user display 176 and a user input system 178. According to some embodiments, the electric modules, power supply, and processing system are located in a panel easily accessible for easy maintenance and technical support. Processing system 180 is also interfaced with a network analyser (not shown). Note that the connection between the network analyser and the sonde is preferably controlled geometrically for calibration purpose. A digital calibration cell is also added to the system, according to some embodiments.

FIG. 2 is a bottom view of a fluid distribution interface and co-axial dielectric probe, according to some embodiments. The flow for fluid saturation on interface 138 is governed by a distributor, made of small slots 210 fed by pipes 220 and 222. Pipes 220 and 222 are connected to the upper conduit 134 shown in FIG. 1. Dam sections such as section 212 and an outer damming ring 214 define slots 210 through which the fluid can communicate with the rock sample.

The dielectric probe 162 is a coaxial termination and includes inner electrode 232 and outer electrode 230 separated by annular space 236. The annular space 236 is filled by a suitable non-conductive dielectric.

According to some embodiments, the lower interface 136 is a simple flow distributor as such shown in FIG. 2, but without the dielectric probe 162. According to some other embodiments, the one or both the upper and lower interfaces also include electrodes (e.g. for resistivity or dielectric measurements), or other measurement sensors, such as acoustic sensors.

The HPHT cell 100 differs from measurements performed in an open laboratory because of the confinement of the plug 110 inside a metallic core holder wall 102. Spurious reflections of the signal on the core holder conducting walls 102, the wiring, and the conduits, under some situations may limit the measurement to reasonably large conductivity rock samples. Conductivity has the effect of limiting the influence of the core holder by attenuation.

There are several ways to calibrate dielectric measurements. In general, a reference in-air (conductivity=0 and a dielectric constant=1) allows the correction of the data for the inversion scheme that provides the complex permittivity of the tested core plug by using the reflection coefficients recorded by a network analyzer. In order to ensure a proper in-air reference inside the dielectric confined cell (in the same range of temperatures and pressures as the experiments on core plugs) a hollow ceramic cylindrical plug can be inserted in place of the core plug to be tested before and after the series of measurements. Two calibration cycles are then recommended: an initial one before the Plug measurements and a second calibration when the plug is removed.

Under some circumstances, the confinement induced by the presence of the metallic walls 102 around the core 110 may affect the performances of the measurements. Numerical modelling of the core inside a sleeve with different conditions has been performed to assess the error on the measurement. FIG. 3 illustrates numerical modelling results of the magnetic field H iso-amplitude lines inside a core plug feed by a coaxial probe, according to some embodiments. The surfaces of inner electrode 232 and of outer electrode 230 can be seen, as well as the core plug region 110. The modelled amplitude is shown as notes “High,” “Med,” and “Low.” As can be seen, the major part of the magnetic radiation is limited in a toroidal region close to the interface between the core plug 110 and the coaxial electrode.

In general, the smaller the probe diameter, the smaller the confinement effect, but for averaging more of the natural heterogeneities in the core plug the largest diameter should be used. These competing requirements result in a compromise when selecting the coaxial probe dimension: it should be large enough to cover heterogeneities and small enough to be effectively immune to confinement effects.

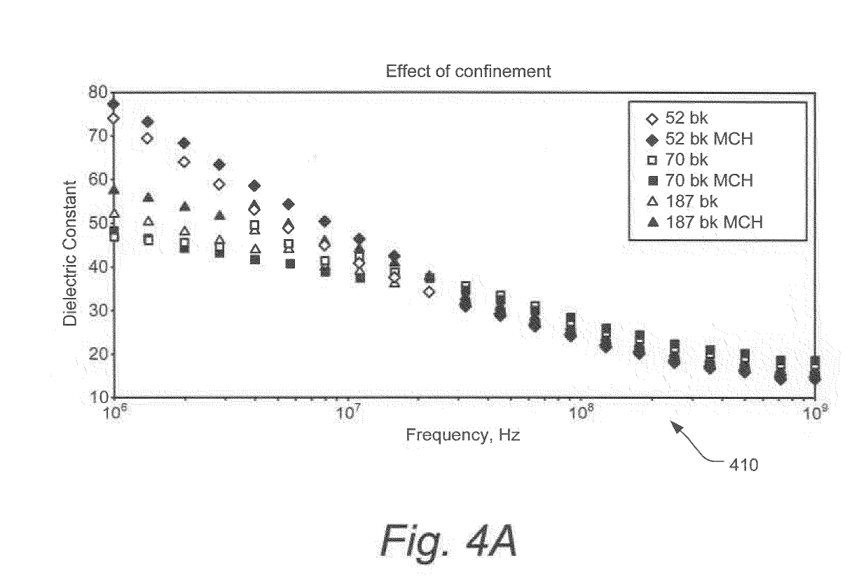

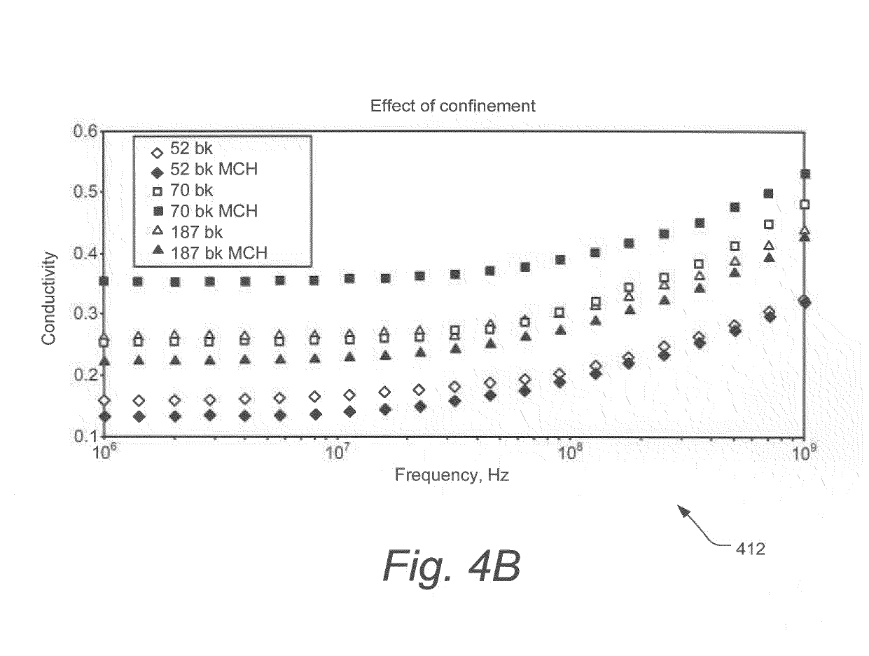

FIGS. 4A-B are plots illustrating the effect of confinement by a metallic core holder instead of a Teflon core for 3 plugs tested with and without metallic core holder, according to some embodiments. In plots 410 and 412 of FIGS. 4A and 4B respectively, measurements carried out with an existing probe are shown with different saturated plugs (numbered “52,” “70,” and “187”) confined in a Teflon or stainless steel core plug holder (labelled “MCH”). The major effect is visible for the lower frequencies for dielectric permittivity. In terms of modelling this corresponds to near field modelling since at frequencies of the order of 10 MHz, for ∈≈40,

$$\frac{λ}{4} = \frac{{c}_{0}}{4 f \sqrt{ɛ}} = 1.7 m ,$$

in comparison with plugs of about 4 to 5 cm long, the quasi-static approximation is valid in this range. The difference is more visible for the conductivity patterns in all the frequency range. A specific calibration is then recommended. The error on conductivity estimate seems much larger than the error on dielectric permittivity. According to some embodiments a correction is implemented, depending on the core holder.

When a layer of air is in between a metallic core holder and the sample to be tested at very low loss (not conductive dry rock) also there is not much visible effect.

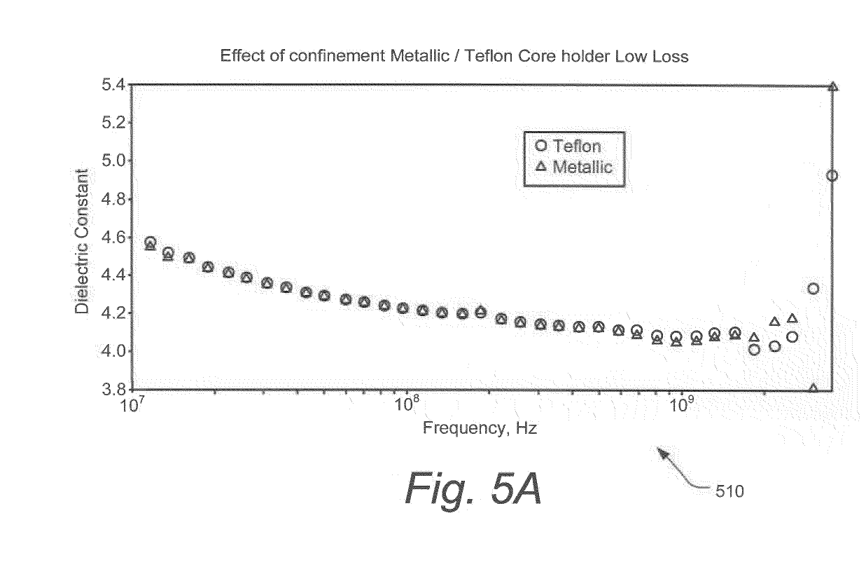

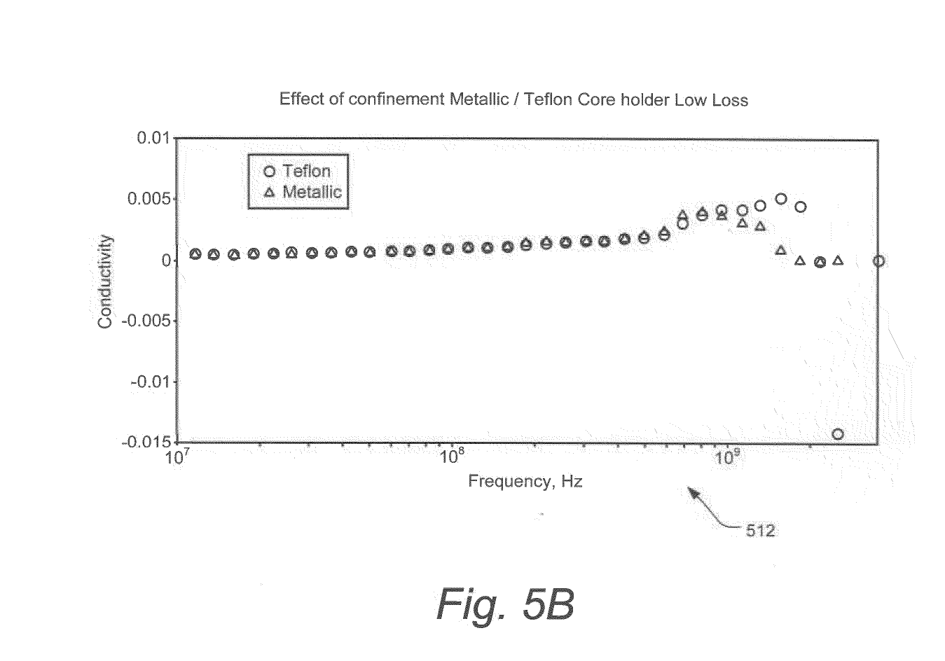

FIGS. 5A-B are plots illustrating the effect of confinement by a metallic core holder instead of a Teflon core holder in air, with a low loss dry carbonate sample, according to some embodiments. As can be seen with plots 510 and 512, the level of conductivity is very low, and the effect of confinement is seen above 1 MHz up to about 3 GHz for conductivity.

According to some embodiments, for resistivity the electrical measurements are done using 2-contact or 4-contact configurations. The 4-contact method is believed to be less affected by electrode polarization and by contact resistance than the direct measurement made with 2 electrodes which simultaneously use voltage electrodes as current injectors.

According to some embodiments, an AC impedance analyzer covering a wide frequency range (0-1 MHz) is included in electronics 140 for the electrical measurements made on rock samples. This ensures a matching between the measurements in the frequency domain of resistivity (100 Hz to 1 MHz) and the complex permittivity (1 MHz to 3 GHz).

Thus, according to some embodiments, a device is provided for dielectric measurement on core plugs, combining 4-points resistivity measurements in controlled Temperature, pressure and saturation environment, with frequency dependent measurements. According to some embodiments, the frequency ranges of the resistivity measurement and the complex permittivity measurements are matched at about 1 MHz, to ensure continuous survey of a large frequency spectrum between 100 Hz and 3.5 GHz.

According to some embodiments, the device includes a dielectric probe applied on one side of the core (for example on the upper section), and includes flow distributors both at both sections of the core plug. According to some embodiments, the device includes a second dielectric probe at the (for example on the lower section) of the core plug, to make measurements in transmission and double reflection modes, combined again with flow distributors and injection electrode for the resistivity measurement.

According to some embodiments, the device includes other sensors against the lower section of the core such as acoustic (or ultrasonic sensors), and/or chemical sensors. According to some embodiments, a fluid (e.g. brine) piping circuit is electrically insulated from the core of the device such a way that it doesn't affect the resistivity measurement. The conduits will be either is very low conductive material of metallic with appropriate coating. Conductive flooding fluids (such as salt brines) are pushed with non-conductive, non-miscible insulating fluids and the fluids will be contained in non-conductive reservoirs.

According to some embodiments, a calibration method for dielectric inversion consisting in air measurements at the same pressure and temperatures of the tests of core plugs by means of a hollow cylinder of known material (such as Teflon or Ceramic) is also provided.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the invention should not be viewed as limited except by the scope and spirit of the appended claims.

What is claimed is:

1. A system for analyzing properties of a core sample of rock from a subterranean rock formation comprising:
a container to hold the core sample;
a temperature control system adapted to maintain the core sample at elevated temperatures; and
a plurality of electrodes dimensioned and arranged to contact the core sample so as to make dielectric measurements on the core sample.

2. A system according to claim 1 wherein the elevated temperature is at least 100 C.

3. A system according to claim 2 wherein the elevated temperature is at least 150 C.

4. A system according to claim 1 wherein the container is sealed and adapted to maintain the core sample at an elevated pressure.

5. A system according to claim 4 wherein the elevated pressure is at least 200 bar.

6. A system according to claim 4 wherein the elevated pressure is substantially the pressure of the subterranean rock formation, and the rock formation includes gas.

7. A system according to claim 1 further comprising a fluid delivery system adapted to expose the core sample to one or more fluids.

8. A system according to claim 7 wherein the one or more fluids is similar in properties to fluids found in the subterranean rock formation.

9. A system according to claim 7 wherein the fluid delivery system includes two conduits for delivering and collecting the one or more fluids, the two conduits being electrically insulated from the core sample.

10. A system according to claim 1 further comprising a plurality of second electrodes arranged to contact the core sample so as to make resistivity measurements on the core sample.

11. A system according to claim 10 wherein the plurality of second electrodes includes at least four second electrodes so as to provide for capability of making 4-point resistivity measurements.

12. A system according to claim 1 further comprising one or more sensors adapted to make measurements on the core plug, the one or more sensors being of a type or types selected from a group consisting of: acoustic, ultrasonic, chemical, and electrical.

13. A system according to claim 1 wherein the plurality of electrodes for making dielectric measurements are arranged as one or more co-axial probes.

14. A method for analyzing properties of a core sample of rock from a subterranean rock formation comprising:
contacting the surface of the core sample with a plurality of electrodes;
maintaining an elevated temperature of the core sample using a temperature control system; and
making dielectric measurements on the core sample using the plurality of electrodes while the core sample is maintained at the elevated temperature.

15. A method according to claim 14 wherein the elevated temperature is at least 150 C.

16. A method according to claim 14 further comprising:
sealing the core sample in a chamber; and
maintaining a pressure within the chamber of at least 200 bar when making the dielectric measurements.

17. A method according to claim 14 further comprising exposing the core sample to one or more fluids that are similar in property to fluids found in the subterranean rock formation.

18. A method according to claim 17 wherein the core sample is exposed to the one or more fluids using a fluid delivery system including two conduits that are electrically insulated from the core sample.

19. A method according to claim 14 further comprising making resistivity measurements on the core sample while the core sample is maintained at the elevated temperature.

20. A method according to claim 19 wherein the resistivity measurements are 4-point resistivity measurements.

21. A method according to claim 14 further comprising calibrating for dielectric inversion by making air measurements at elevated temperatures in a hollow cylinder of known materials.
